(19) United States
(12) Patent Application Publication
(10) Pub. No.: US 2018/0334307 A1
(43) Pub. Date: Nov. 22, 2018

(54) SHIPPING CONTAINER RECONFIGURABLE AS AN ARTIST'S EASEL

(71) Applicant: Creations & Libations, LLC, Beaufort, SC (US)

(72) Inventor: Carissa Marie Doig, Beaufort, SC (US)

(73) Assignee: Creations & Libations, LLC, Beaufort, SC (US)

(21) Appl. No.: 15/983,896

(22) Filed: May 18, 2018

Related U.S. Application Data
(60) Provisional application No. 62/508,110, filed on May 18, 2017.

(51) Int. Cl. B65D 81/36; B65D 5/20; B44D 3/12; A47B 97/08

(52) U.S. Cl. CPC B65D 81/368; A47B 97/08; B44D 3/125; B65D 5/2052

(57) ABSTRACT

A reconfigurable shipping container that is configurable to a closed state to store and ship artistic supplies and reconfigurable to be an easel includes a lid that is foldable from the closed state used to store and ship artistic supplies to an easel state used to provide a surface against which a canvass may be placed. The lid is supported by support flaps to maintain the lid in the easel state, and the support flaps extend from the lid. An easel support, extends from the lid to provide a surface on which a canvas may be placed when the reconfigurable shipping container is reconfigured to be the easel. An easel retainer coordinates with the support flaps to configure the reconfigurable shipping container into the easel.

### REFERENCE TO RELATED APPLICATION

This application claims priority to U.S. Provisional Patent Application No. 62/508,110, filed on May 18, 2017, the entire contents of the provisional application being incorporated herein by reference.

### BACKGROUND

Painting, drawing and other artistic endeavors are very popular pastimes for many individuals. Engaging in these pastimes requires multiple pieces of equipment, each of which is generally sold separately. For example, painting requires paint, a paintable surface (e.g. a pad, an artist's canvas, a piece of paper, a board etc.), an easel, a palette, brushes, etc. Gathering all of these supplies can be time consuming, and having these supplies shipped to a customer typically requires multiple packages, which can be time consuming and inconvenient. This is especially true because easels are usually large, requiring a large shipping container to transport the easel. It would be convenient and advantageous to have a shipping container that could store all of the supplies needed for painting, or other artistic pastimes, and to have that shipping container be reconfigurable into an easel so that everything the user needs for the pastime can be shipped and stored in a single container of reasonable size. This type of all-in-one system would allow the end user to receive in a single package all of the components needed to engage in the past time and would also reduce the cost of the pastime by allowing the shipping container to serve as the easel. Additionally, the shipping container may include other items needed by the end user, such as a brush holder, which makes engaging in these artistic pastimes more enjoyable, easier, more convenient, less expensive, etc.

### BRIEF DESCRIPTION OF THE DRAWINGS

FIGS. 1A and 1B illustrate a non-limiting example embodiment in which the assemblies, systems, methods, technologies and/or techniques, described herein, may be implemented.

FIGS. 2A through 2B illustrate views of the reconfigurable shipping container of FIGS. 1A through 1C configured to be used as an easel.

FIG. 3 illustrates a front perspective view of the reconfigurable &hipping container of FIGS. 1A through 2D configured to be used an easel.

FIGS. 4A & 4B illustrate a top plan view and a front elevation view, respectively, of the reconfigurable shipping container of FIGS. 1A through 3 in the closed position.

### SUMMARY

In one embodiment described herein, a reconfigurable shipping container that is configurable to a closed state to store and ship artistic supplies and reconfigurable to be an easel includes a lid that is foldable from the closed state used to store and ship artistic supplies to an easel state used to provide a surface against which a canvas may be placed. The lid is supported by support flaps to maintain the lid in the easel state, and the support flaps extend from the lid. The reconfigurable shipping container further includes an easel support extendable from the lid to provide a surface on which a canvas may be placed when the reconfigurable shipping container is reconfigured to be the easel. The reconfigurable shipping container further includes an easel retainer which coordinates with the support flaps to configure the reconfigurable shipping container into the easel. The reconfigurable shipping container may further include sides that extend from a bottom of the reconfigurable shipping container, and the sides may include the easel retainer. The sides may include a first side panel, a second side panel, and a third side panel, and the first side panel, second side panel and third side panel may form a cavity when the reconfigurable shipping container is in the closed state or when the reconfigurable shipping container is reconfigured to serve as an easel. The easel retainer may be located on the second side panel. The reconfigurable shipping container may further include a lid flap that extends from the lid and a retaining flap that extends from the lid flap. The lid flap may cover a front when the reconfigurable shipping container is in the closed state. The front may extend from a bottom of the reconfigurable shipping container. The retaining flap may engage a cavity of a side to maintain the reconfigurable shipping container in the closed position. The lid may be about 70 to 80 degrees from the closed position when the reconfigurable shipping container is reconfigured as the easel. The lid may be about 75 degrees from the closed position when the reconfigurable shipping container is reconfigured as the easel. The easel retainer may correspond to one or more of a slot, a bracket, or a mechanical fastener. The easel support may be a one-piece design. The easel support may be formed as a part of the lid. The reconfigurable shipping may further include a lid flap that is detachable from the lid, the lid flap including a retaining flap that coordinates with the easel retainer when the detachable lid flap is detached to allow the lid flap to provide additional support to the reconfigurable shipping container when the reconfigurable shipping container is configured to be an easel.

In another embodiment described herein, an all-in-on system for artistic endeavors includes a reconfigurable shipping container that that is configurable to store and ship artistic supplies and reconfigurable to be an easel. The reconfigurable shipping includes a lid that is foldable from a closed state used to store and ship artistic equipment to an easel state used to support a canvas. The lid is supported by support flaps to maintain the lid in the easel state. The lid includes an easel support extendable from the lid to a position to provide a surface on which a canvas may be placed when the reconfigurable shipping container is reconfigured to be an easel. The all-in-one system for artistic endeavors further includes one or more artistic supplies selected from a group consisting of paint, a paint brush, a pencil, or a canvas. The artistic supplies fit within the reconfigurable shipping container when the reconfigurable shipping container is in the closed state. The all-in-one system for artistic endeavors may further include a beverage that fits within the reconfigurable shipping container when the reconfigurable shipping container is in the closed state. The all-in-one system for artistic endeavors may further include a black light that fits within the reconfigurable shipping container when the reconfigurable shipping container is in the closed state. The canvas may correspond to an artist's canvas, a pad, or a board.

In another embodiment described herein, a reconfigurable shipping container that is configurable to store and ship artistic supplies and configurable to be an easel includes a lid that is foldable from a closed state used to store and ship artistic equipment to an easel state used to support a canvas. The lid is supported by support flaps to maintain the lid in the easel state, and the support flaps extend from the lid. The reconfigurable shipping container further includes a back extending from the lid, a bottom extending from the back, two sides extending from the bottom, and a front extending from the bottom. The reconfigurable shipping container further includes an easel support extendable from the lid to a position to provide a surface on which a canvas may be placed when the reconfigurable shipping container is reconfigured to be the easel. The reconfigurable shipping container further includes two easel retainers located on the two sides, each of the two easel retainers coordinating with one of the support flaps to configure the reconfigurable shipping container into the easel. The reconfigurable shipping container may further include a detachable lid flap extending from the lid and including a pair of retaining flaps. The pair of retaining flaps are configured to engage the two easel retainers when the detachable lid flap is detached to provide additional support to the reconfigurable shipping container when the reconfigurable shipping container is configured to be an easel. The reconfigurable shipping container may further include a handle connected to a side of the two sides.

### DETAILED DESCRIPTION OF THE DRAWINGS

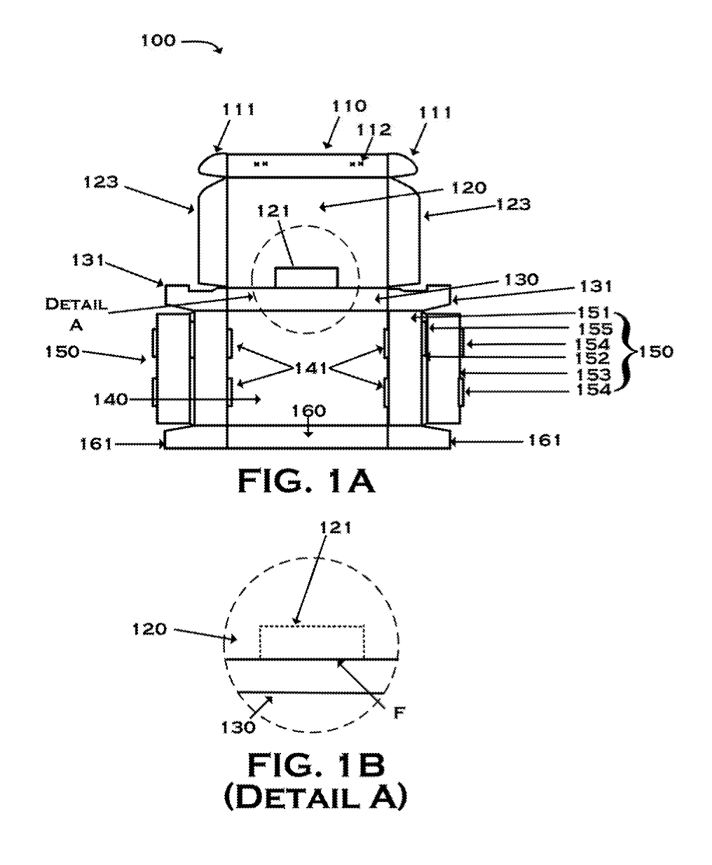

FIGS. 1A through 4B are attached hereto and fully incorporated herein. The following detailed description refers to the embodiments and environments depicted in the accompanying FIGS. 1A to 4B. The disclosure herein is not limited to the embodiments or environments depicted herein. The disclosure herein is being made for the purpose of illustrating the general principles of the invention by describing specific examples. The assemblies, systems, methods technologies and/or techniques described herein may be implemented in a variety of different embodiments and, in other environments than those depicted in the accompanying Figures without departing from the spirit and scope of the disclosure herein.

The assemblies, systems, methods technologies and/or techniques described herein may include a reconfigurable shipping container that may be configured to store and ship artistic supplies and reconfigured to be used as an easel. The reconfigurable shipping container may include components that are easily configured by a user to change the reconfigurable shipping container from a shipping container to an easel. Reconfiguring the shipping container may include, for instance, separating easel supports from a panel of the shipping container and placing a portion of the shipping supports in a support lock located on the lid. Reconfiguring the shipping container may further include placing easel tabs located on lid flaps into easel retainers located on the sides of the shipping container. Reconfiguring the shipping container may also, or alternatively, include removing a palette from an insert located within the shipping container and/or from a panel of the shipping container. Reconfiguring the shipping container may also, or alternatively, include placing brushes, pencils, or other drawing or painting tools through slits located in the reconfigurable shipping container and/or an insert located within the reconfigurable shipping container. The reconfigurable shipping container may be formed from a flat cardboard blank or from one or more other materials. When the reconfigurable shipping container is formed into a shipping container, items may be stored and/or shipped within the reconfigurable shipping container.

FIGS. 1A and 1B illustrate a non-limiting example embodiment of a reconfigurable shipping container in which the assemblies, systems, methods, technologies and/or techniques described herein may be implemented. For example, the reconfigurable shipping container 100 may include a lid flap 110, retaining flaps 111, slits 112, a lid 120, easel support 121, support flaps 123, a back 130, back flaps 131, a bottom 140, side retainers 141, sides 150, a front 160 and front flaps 161. Each Side 150 may include a first side panel 151, a second side panel 152, a third side panel 153, side tabs 154 and an easel retainer 155. The components shown in FIGS. 1A and 1B are provided for explanatory purposes only, and the disclosure herein is not intended to be limited to the components provided in FIGS. 1A and 1B. There may be additional components, fewer components, different components, and/or differently arranged components than what is illustrated in FIGS. 1A and 1B. Also, in some implementations, one or more of the components of reconfigurable shipping container 100 may perform one or more functions described as being performed by another one or more of the components of reconfigurable shipping container 100. Reconfigurable shipping container 100 may be configured into a shipping container or an easel when the panels are folded into a position using the tab and slot/retainer system (as shown), which is frequently used to form corrugated cardboard blanks into boxes, as well as other methods of assembly, such as adhesives, tape, mechanical fasteners, etc.

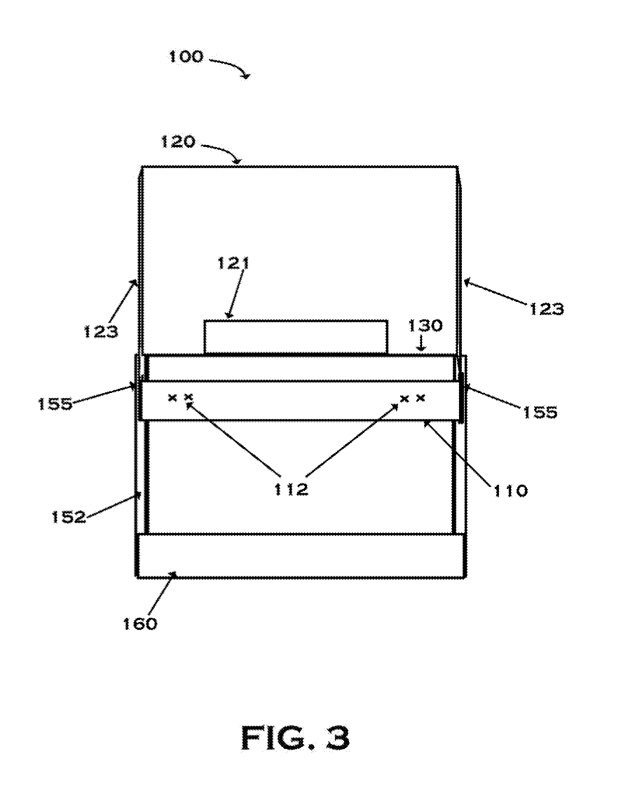

The panels, tabs, retainers, and other components of reconfigurable shipping container 100 may coordinate to form reconfigurable shipping container from a flat panel into a shipping container. Folding similar flat panels into shipping containers is well known in the art. For instance, U.S. Pat. No. 5,175,702 describes a foldable box made from corrugated cardboard that folds into a shipping container. In this embodiment of the present invention, lid flap 110 may be a panel of reconfigurable shipping container 100 that may extend from cover 120 and may reside over front 160 when the reconfigurable shipping container 100 is configured into a shipping container and placed in the closed position (i.e. for shipping, storage, etc.). A pair of retaining flaps 111 may extend from opposing sides of lid flap 110. To maintain the reconfigurable shipping container 100 in a closed position, retaining flaps 111 may be placed within a cavity formed by folding components of sides 150 as further described herein. As further discussed in reference to FIG. 3, lid flap 110 may be removed from lid 120 and used to support the reconfigurable shipping container 100 in the easel state. Lid flap 110 may also, or alternatively, include slits 112, which may correspond to penetrations (e.g. apertures, cuts, etc.) that may be used to hold paintbrushes, pencils, markers, or other artistic tools, especially when the reconfigurable shipping container 100 is configured in the easel state.

Lid 120 may be a panel of reconfigurable shipping container 100 that may serve as a cover when the reconfigurable shipping container 100 is in the closed position and that may also, or alternatively, serve as an easel by providing a surface against which a canvas or other artistic medium (e.g. paper, pad, a board, any substrate on which a user may paint or draw, collectively a referred to as “canvas” in this application) may be placed. Easel support 121 may be a portion of reconfigurable shipping container 100 that provides a surface on which a canvas may be placed. While easel support 121 is depicted as a single piece of material that is formed from a part of lid 120, easel support 121 may be one or more pieces and may be separate from, or formed as a part of, any of the panels of reconfigurable shipping container. If easel support 121 is not formed from a panel, easel support 121 (which may include multiple components) may be connected or connectable to lid 120 or another panel to provide a surface for a canvas when the reconfigurable shipping container is placed in the easel position.

As shown in FIG. 1B, easel support 121 may extend from lid 120 to support a canvas by disconnecting three sides of easel support 121 (i.e. the three sides shown in dashed lines) from lid 120. Disconnecting the three sides of easel support 121 may include, for instance, pushing easel support 121 while holding lid 120 to cause perforations along the three sides to tear and allow easel support 121 to fold out from lid 120 along Fold line F.

Support flaps 123 may be panels that extend from lid 120 (or other panel against which a canvas may be placed when the reconfigurable shipping container 100 is reconfigured into an easel) and that support the lid 120 when the lid 120 is providing a surface against which a canvas may be placed. Support flaps 123 may be placed inside of reconfigurable shipping container 100 adjacent to sides 150 when reconfigurable shipping container 100 is in the closed position. When reconfigurable shipping container 100 is configured to support a canvas, a portion of support flaps 123 may be placed inside easel retainer 155, which may prevent reconfigurable shipping container 100 from closing, such as due to the weight of a canvas, when a user paints or draws on a canvas, etc. As described in reference to FIG. 3, lid flap 110 may be removable and may also, or alternatively, support reconfigurable shipping container 100 in the easel position.

Back 130 may correspond to a panel of reconfigurable shipping container 100 that forms a back portion of reconfigurable shipping container 100 when the reconfigurable shipping container 100 is in the closed position. Back flaps 131 may extend from back 130 and may be used to place the reconfigurable shipping container 100 into a container position and/or easel position by placing back flaps 131 inside of a cavity formed by a side 150. Front 160 may correspond to a panel of reconfigurable shipping container 100 that forms a from portion of reconfigurable shipping container 100 (opposite back 130) when the reconfigurable shipping container 100 is in the closed position. Front flaps 161 may extend from front 160 and may be used to place the reconfigurable shipping container 100 into a container position and/or easel position by placing each of from flaps 161 inside of a cavity formed by a side 150.

Bottom 140 may correspond to a panel of reconfigurable shipping container 100 that forms the bottom (i.e. opposite lid 120) of the reconfigurable shipping container 100 when the reconfigurable shipping container 100 is in the closed position. Bottom 140 may include side retainers 141 which may correspond to slots within which side tabs 154 may be placed to form a cavity within sides 150 and to form the panels of sides 150 into the desired shape (i.e. the shape of a shipping container and/or easel).

Sides 150 may include one or more panels that form the sides of a shipping container. As shown in FIG. 1A, sides may include a first side panel 151, a second side panel 152, a third side panel 153, side tabs 154 and easel retainers 155. Easel retainers 155 may coordinate with support flaps 123 (e.g. allowing a portion of support flaps 123 to be inserted into easel retainers 155, etc.) to maintain the lid in the easel position (i.e. to keep the lid from closing due to the weight of the canvas, due to forces applied to the lid by a user, etc.). While easel retainers 155 are depicted as slots in the embodiment described herein, easel retainers 155 may be other forms of structure, including mechanical fasteners, tape, brackets that hold support flaps 123, etc.

To form the panels of sides 150 into the sides of a shipping container, some of the panels of reconfigurable shipping container 100 must be folded into position. Back 130 and front 160 are folded about 90 degrees along the seams these panels share with bottom 140. Back flaps 131 and front flaps 161 are then folded 90 degrees from back 130 and front 160, respectively, which brings back flaps 131 and front flaps 161 close to each other above bottom 140. First side panel 151 is then folded about 90 degrees up from bottom 140, which makes first side panel 151 approximately adjacent to back flap 131 and front flap 161. Second side panel 152 and third side panel 153 are then wrapped around back flap 161 and front flap 131 by folding second side panel 152 90 degrees from first side panel 151, which places second side panel 152 over back flap 161 and front flap 131, and then folding third side panel 153 downward 90 degrees from second side panel 152, which places side tabs 154 near side retainers 141. Side tabs 154 are then inserted into side retainers 141 to form an open square or rectangular box with bottom 140 on the bottom, back 130 and front 160 opposite each other and extending from bottom 140, and sides 150 opposite each other. In this configuration, the panels of sides 150 form a cavity within which back flap 131 and front flap 161 are retained and into which retaining flaps 111 may be placed when the lid is folded to the closed position (i.e. parallel with bottom) to retain reconfigurable shipping container 100 in the closed position. Additionally, or alternatively, retaining flaps 111 may be placed in the cavity formed within sides 150 when lid flap 110 is removed and retaining flaps 111 are placed in easel retainers 155 as shown in FIG. 3.

To reconfigure the reconfigurable shipping container 100 from a shipping container into an easel from the closed position, the retaining flaps 111 are removed from the cavities within sides 150. Then, the lid 120 is opened approximately 90 degrees from the closed position and support flaps 123 are aligned with easel retainers 155. The lid 120 is then folded back towards the closed position until support flaps 123 are inserted into easel retainers 155. This results in an angle of lid (against which canvas will be placed) which can vary depending upon the design. Ideally, the angle is at least 45 degrees from the closed position, more ideally about 70-80 degrees from the closed position, preferably 75 degrees. The size, location, type (e.g. penetrations, brackets, mechanical fasteners, etc.) and shape of easel retainers 155 may be changed to alter the angle of easel or to slightly modify the process used to place the reconfigurable shipping container 100 into the easel position without departing from the scope of the disclosure herein. Additionally, or alternatively, the size shape and location of support flaps 123 may be adjusted modify the angle of easel or the method used to place the reconfigurable shipping container 100 into an easel without departing from the scope of the disclosure herein. When the support flaps 123 are placed in easel retainers 155, the reconfigurable shipping container 100 is reconfigured into an easel and ready to support a canvas. Additionally, as shown in FIG. 3, lid flap 110 may be removed (e.g. by tearing it off, such as along a perforation, cutting it off, or otherwise removing lid flap 110 from lid 120) from lid 120 and used to further support the reconfigurable shipping container 100 in the easel position.

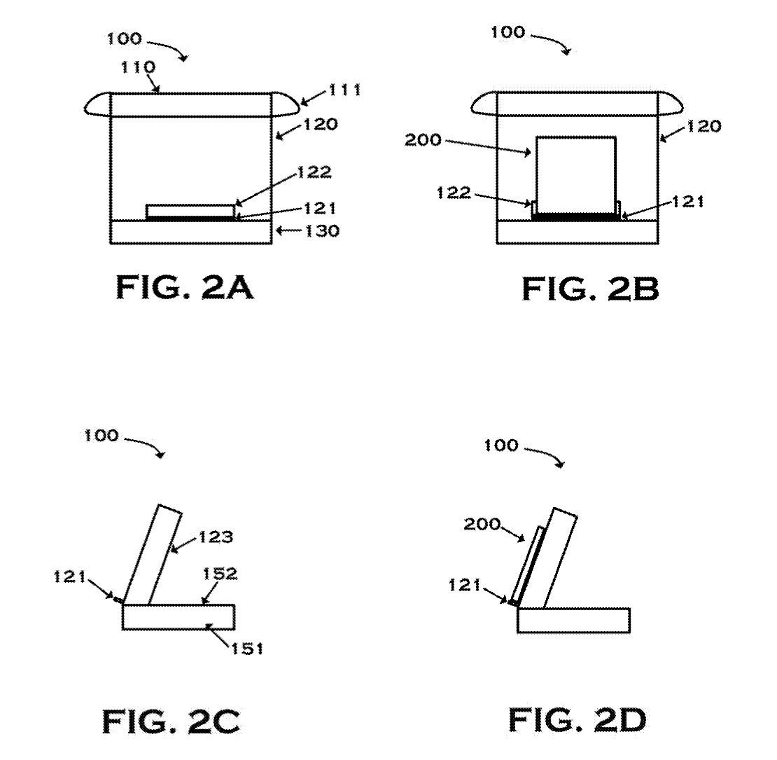

FIGS. 2A through 2D illustrate views of the reconfigurable shipping container 100 configured to be used as an easel. As shown in in FIGS. 2A and 2B, when the easel support 121 is placed in a position to support a canvas (the “easel state”), easel support 121 may fold out from lid 120 to provide a surface on which canvas 200 may be placed. A void 122, which corresponds to a portion of lid 120 that formed easel support 121, may be left when easel support 121 is placed in the easel state. Lid flap 110 is depicted as attached to lid 120 in FIGS. 1A and 1B. As shown in FIGS. 2C and 2D, support flaps 123 are supported by second side panel 152, and first side panel 151 forms the outside panel of sides 150. Easel supports 121 provide a surface on which canvas 200 may be placed. Lid flap 110 has been removed from lid 120 and retaining flaps 111 are placed within easel retainers 155.

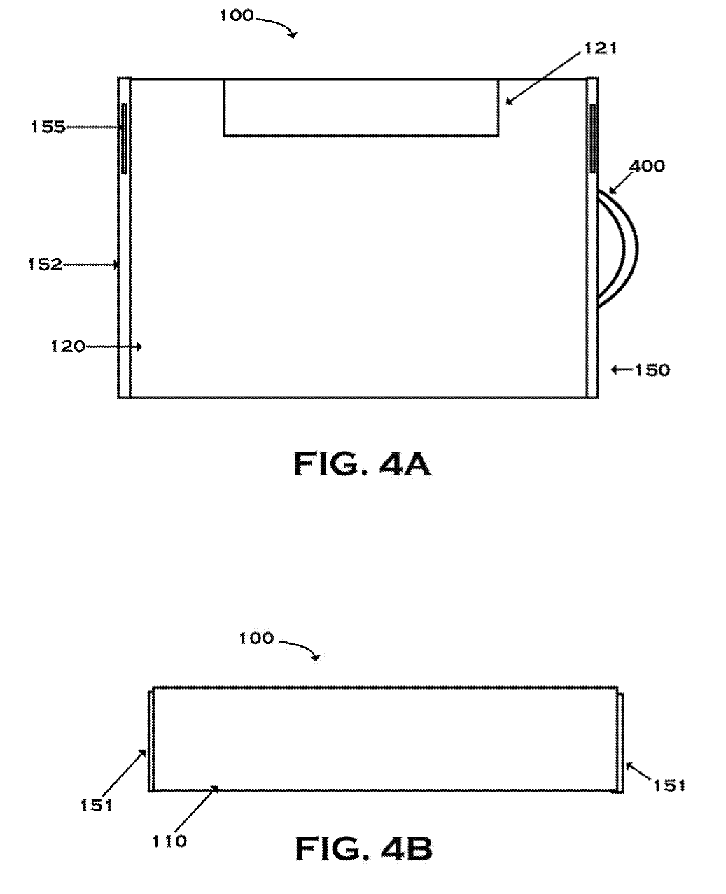

FIG. 3 illustrates a front perspective view of reconfigurable shipping container 100 configured to be used an easel and depicting lid flap 110 placed in a position to provide support to reconfigurable shipping container 100. As shown in FIG. 4, support flaps 123 ate resting on second side panel 15 and are partially inserted into easel retainers 155. Easel support 121 has not yet been extended from lid 120. Lid flap 110 has been removed from lid 120 and placed across bottom 140 such that a retaining flap 111 is placed in each easel retainer 155. When lid flap 110 is in this position, lid flap 110 may provide additional support to reconfigurable shipping container 100, which may prevent reconfigurable shipping container 100 from buckling, bending or otherwise failing when the reconfigurable shipping container is in the easel state and forces are applied to the reconfigurable shipping container 100 (e.g. forces from the artist on the canvas, such as when bearing down, the weight of the canvas, etc.) Also, slits 112 may provide a place for a user to place paintbrushes, etc., in this configuration.

In this view, it is easily seen that artistic supplies such as canvas, etc. may be placed in the reconfigurable shipping container for transportation. According to the disclosure herein, an all-in-one system for artistic endeavors may be provided to a user. The all in one system may include the reconfigurable shipping container 100 as well as additional artistic supplies (e.g. paint, paint brushes, pencils, canvas, etc.) placed within the reconfigurable shipping container 100. When such supplies are provided, all of the supplies needed for a paint-at-home event may be provided within the reconfigurable shipping container 100 and easily shipped to a user, including those supplies(e.g. beverages, black lights, etc.) used by create and sip (i.e. wine and paint) boutique studios or galleries, which host wine and paint sessions. This would allow wine and paint events to be easily held at a user's home or other location.

FIGS. 4A & 4B illustrate a top plan view and a front elevation view, respectively, of the reconfigurable shipping container 100 in the closed state. As shown in FIGS. 4A & 4B, in the closed state, reconfigurable shipping container 100 may take on the size and/or shape of a conventional shipping container, making the reconfigurable shipping container 100 and all supplies within it easy to ship and convenient to store. Easel support 121 is located on lid 120 and has not been extended from and/or removed from lid 120. When converted into an easel, easel support 121 is extended, folded and/or removed (partially or completely) from lid 120. Easel retainers 155 are observed on second side panels 152 of sides 150, and lid flap 110 covers front 160 (not shown). Retaining flaps 111 (not shown) have been inserted into the cavities formed by sides 150 to maintain the reconfigurable shipping container in the closed position.

Also depicted in FIG. 4A is a handle 400 connected to a side 150 of reconfigurable shipping container 100. Handle 400 may be a strip of material (e.g. a plastic strip, a portion of side 150, etc.) that is connected to (e.g. mechanically fastened such as with mechanical fasteners or adhesive, formed as part of, etc.) a panel of reconfigurable shipping container 100 that a user may grasp to carry the reconfigurable shipping container 100, such as when the reconfigurable shipping container is in the closed position.

The foregoing description provides illustration and description, but is not intended to be exhaustive or to limit the implementations to the precise form disclosed. Modifications and variations are possible in light of the above disclosure or may be acquired from practice of the embodiments. It will be apparent that the assemblies, systems, methods, technologies and/or techniques, as described above, may be implemented in many different forms of implementations described herein and illustrated in the figures. The actual or specialized components and/or materials used to implement the assemblies, systems, methods, technologies and/or techniques is not limited to the embodiments; it should be understood that components and/or materials may be designed to implement the assemblies, systems, methods, technologies and/or techniques based on the description herein.

It should be emphasized that the terms “comprises”/“comprising” when used in this specification are taken to specify the presence of stated features, integers, steps or components but does not preclude the presence or addition of one or more other features, integers, steps, components, or other groups thereof.

No element, act or instruction used in the present application should be construed as critical or essential to the embodiments unless explicitly described as such. Also, as used herein, the articles “a” and “an” are intended to include one or more items and may be used interchangeably with “one or more.” Where only one item is intended, the term “one” or similar language is used. Further, the phrase “based on” is intended to mean “based, at least in part, on” unless explicitly stated otherwise.

While preferred embodiments of the invention have been shown and described, those skilled in the art will recognize that other changes and modifications may be made to the foregoing embodiments without departing from the scope and spirit of the invention. For example, specific shapes of various elements of the illustrated embodiments may be altered to suit particular applications. Additionally, the reconfigurable shipping container may have different components or be designed in different shapes using different methods of connection without departing from the spirt of the invention disclosed herein. For example, while many of the components of reconfigurable shipping container are depicted as having a panel design, the components may be formed from non-panel construction. Additionally, or alternatively, various components may be added to and/or subtracted from reconfigurable shipping container without departing from the spirit of the invention. Further, the embodiments disclosed herein may be used in different applications. It is intended to claim all such changes and modifications as fall within the scope of the disclosure herein and the equivalents.

What is claimed is:

1. A reconfigurable shipping container that is configurable to a closed state to store and ship artistic supplies and reconfigurable to be an easel, the reconfigurable shipping container comprising:
a lid that is foldable from the closed state used to ore and ship artistic supplies to an easel state used to provide a surface against which a canvas may be placed,
the lid being supported by support flaps to maintain the lid in the easel state,
the support flaps extending from the lid;
an easel support extendable from the lid to provide a surface on which a canvas may be placed when the reconfigurable shipping container is reconfigured to be the easel;
an easel retainer which coordinates with at least one of the support flaps to reconfigure the reconfigurable shipping container into the easel.

2. The reconfigurable shipping container of claim 1, further comprising sides that extend from a bottom of the reconfigurable shipping container, the sides including the easel retainer.

3. The reconfigurable shipping container of claim 2, where the sides include a first side panel, a second side panel, and a third side panel,
the first side panel, second side panel and third side panel forming a cavity when the reconfigurable shipping container is in the closed state or when the reconfigurable shipping container is reconfigured to serve as an easel, and
the easel retainer located on the second side panel.

4. The reconfigurable shipping container of claim 1 further including a lid flap extending from the lid and a retaining flap extending from the lid flap,
the lid flap covering a front when the reconfigurable shipping container is in the closed state,
the front extending from a bottom of the reconfigurable shipping container, and
the retaining flap engaging a cavity of a side to maintain the reconfigurable shipping container in the closed position.

5. The reconfigurable shipping container of claim 4 further including a slit in the lid flap.

6. The reconfigurable shipping container of claim 1, where the lid is about 70 to 80 degrees from the closed position when the reconfigurable shipping container is reconfigured as the easel.

7. The reconfigurable shipping container of claim 6 where the lid is about 75 degrees from the closed position when the reconfigurable shipping container is reconfigured as the easel.

8. The reconfigurable shipping container of claim 1, where the easel retainer corresponds to one or more of:
a slot,
a bracket,
or a mechanical fastener.

9. The reconfigurable shipping container of claim 1, where the easel support is a one-piece design.

10. The reconfigurable shipping container of claim 1, where the easel support is formed as a part of the lid.

11. The reconfigurable shipping container of claim 1, further including lid flap that is detachable from the lid, the lid flap including a retaining flap that coordinates with the easel retainer when the detachable lid flap is detached to allow the lid flap to provide additional support to the reconfigurable shipping container when the reconfigurable shipping container is configured to be an easel.

12. An all-in-on system for artistic endeavors comprising:
a reconfigurable shipping container that that is configurable to store and ship artistic supplies and reconfigurable to be an easel,
the reconfigurable shipping container including a lid that is foldable from a closed state used to store and ship artistic equipment to an easel state used to support a canvas,
the lid being supported by support flaps to maintain the lid in the easel state,
the lid including an easel support extendable from the lid to a position to provide a surface on which a canvas may be placed when the reconfigurable shipping container is reconfigured to be an easel;
one or more artistic supplies selected from a group consisting of:
a paint, a paint brush, a pencil, or a canvas,
the one or more artistic supplies fitting within the reconfigurable shipping container when the reconfigurable shipping container is in the closed state.

13. The all-in-one system for artistic endeavors of claim 12 further including a beverage, the beverage fitting within the reconfigurable shipping container when the reconfigurable shipping container is in the closed state.

14. The all-in-one system for artistic endeavors of claim 12 further including a black light, the black light fitting within the reconfigurable shipping container when the reconfigurable shipping container is in the closed state.

15. The all-in-one system for artistic endeavors of claim 12, where the canvas corresponds to an artist's canvas, a pad, or a board.

16. A reconfigurable shipping container that is configurable to store and ship artistic supplies and reconfigurable to be an easel, the reconfigurable shipping container comprising:
a lid that is foldable from a closed state used to store and ship artistic equipment to an easel state used to support a canvas,
the lid being supported by support flaps to maintain the lid in the easel state,
the support flaps extending from the lid;
a back extending from the lid,
a bottom extending from the back,
two sides extending from the bottom,
a front extending from the bottom,
an easel support extendable from the lid to a position to provide a surface on which a canvas may be placed when the reconfigurable shipping container is reconfigured to be the easel;
two easel retainers located on the two sides, each of the two easel retainers coordinating with one of the support flaps to configure the reconfigurable shipping container into the easel.

17. The reconfigurable shipping container of claim 16 further including a detachable lid flap extending from the lid and including a pair of retaining flaps, the pair of retaining flaps configured to engage the two easel retainers when the detachable lid flap is detached to provide additional support to the reconfigurable shipping container when the reconfigurable shipping container is configured to be an easel.

18. The reconfigurable shipping container of claim 16 further including a handle connected to a side of the two sides.
